(19) United States
(12) Patent Application Publication
(10) Pub. No.: US 2008/0061698 A1
(43) Pub. Date: Mar. 13, 2008

(54) Plasma display panel with intra pixel dielectric stand

(75) Inventor: Qun Yan, Wallkill, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: MATSUSHITA ELECTRIC INDUSTRIAL CO., LTD.

(21) Appl. No.: 11/519,464

(22) Filed: Sep. 12, 2006

(51) Int. Cl. H01J 17/49

(52) U.S. Cl. 313/586; 313/582

(57) ABSTRACT

A plasma display panel comprising a front plate having scan electrodes and sustain electrodes for each row of pixel sites; a back plate having a plurality of column address electrodes disposed thereon; a dielectric layer covering the column address electrodes; a plurality of barrier ribs disposed above the dielectric layer separating the column address electrodes and being in spaced adjacency therewith; a red phosphor layer, a green phosphor layer and blue phosphor layer sequentially disposed on top of the dielectric layer between the barrier ribs; and a dielectric stand disposed between the scan electrodes and the sustain electrodes and on top of a dielectric layer on the front plate, to lengthen the discharge path created when a voltage is applied across the electrodes. The dielectric stand can be of varying lengths and heights.

### BACKGROUND OF THE INVENTION

1. Field of the Invention

The present disclosure relates to a novel plasma display panel structure. More particularly, the present disclosure relates to a dielectric step or stand between two electrodes across a sustain gap on the front plate in each sub-pixel of plasma displays.

2. Description of the Related Art

Most commercial plasma display panels (PDPs) are of the surface discharge type. The constitution of a plasma display panel of the prior art is described below with reference to the accompanying drawing.

FIG. 1 is a perspective view of a portion of a conventional AC color PDP. An AC PDP can include a front plate assembly and a back plate assembly. Front plate assembly includes a front plate 110, which is a glass substrate, sustain electrodes 111, and scan electrodes 112, for each row of pixel sites. The front plate assembly also includes a dielectric glass layer 113 and a protective layer 114. The protective layer 114 is preferably made of magnesium oxide (MgO).

The back plate assembly includes a glass back plate 115 upon which plural column address electrodes or data electrodes 116 are located. The data electrodes 116 are covered by a dielectric layer 117. A plurality of barrier ribs 118 are also on the back plate assembly. Red phosphor layer 120, green phosphor layer 121, and blue phosphor layer 122 are located on top of the dielectric layer 117 and along the sidewalls created by barrier ribs 118. Thus, each pixel of the PDP is defined as a region proximate to an intersection of (i) a row including sustain electrode 111 and scan electrode 112, and (ii) three column address electrodes 116, one for each of red phosphor layer 120, green phosphor layer 121, and blue phosphor layer 122.

FIG. 2 is a side view of a portion of a PDP, specifically of a sub-pixel 100 corresponding to green phosphor layer 121, and taken along a plane perpendicular to the long dimension of address electrode 116. In a surface discharge type PDP, an inert gas mixture, such as Ne—Xe, fills a space 125 between the front and back plate assemblies. A gas discharge is generated by a voltage applied between sustain electrode 111 and scan electrode 112 (not shown in the figure), which creates vacuum ultraviolet (VUV) light that excites the red, green, and blue phosphor layers, respectively to emit visible light. For example, green phosphor 121, as shown in FIG. 2, is excited by the VUV light to generate green light from green phosphor layer 121.

FIG. 3 is another side view of PDP, taken along a plane parallel to the long dimension of address electrode 116, and showing sub-pixel 100 in a plane perpendicular to the plane of FIG. 2. FIG. 3 shows a sub-pixel, which is an area defined by transparent sustain electrode 111 and scan electrode 112 on the front plate, and data electrode 116 on the back plate. Transparent sustain electrode 111 has an adjacent bus electrode 110 connected thereto, and transparent scan electrode 112 has an adjacent bus electrode 113 connected thereto. Bus electrodes 110 and 113 are typically opaque.

The operating sustain voltage of the PDP is determined by the geometry of a sustain gap 130, dielectric layers, the particular gas mixture used, and a secondary electron emission coefficient of the protective MgO layer 114 on the front plate. The brightness in the color PDP results from the visible light from phosphor layers by UV light generated in the sustain gap discharges.

Initiation of sustain discharges is achieved by an addressing discharge across a plate gap 131 prior to the sustain discharges, described in further detail below. A full color image is generated by appropriately controlling the driving voltage on sustain electrodes 111, scan electrodes 112, and addressing electrodes 116.

In operation, as shown in FIG. 4, the plasma display partitions a frame of time into sub-fields, each of which produces a portion of the light required to achieve a proper intensity of each pixel. Each sub-field is partitioned into a setup period, an addressing period and a sustain period. The sustain period is further partitioned into a plurality of sustain cycles.

The setup period resets any ON pixels to an OFF state, and provides priming to the gas and to the surface of protective layer 114 to allow for subsequent addressing. In the setup period, it is desirable that each interior surface of the pixel's electrodes is placed at a voltage very close to a firing voltage of the gas.

During the addressing period, the sustain electrodes are driven with a common potential, while scan electrodes are driven such that a row of pixels is selected so that pixels in that row can be addressed via an addressing discharge triggered by an application of a data voltage on a vertical column electrode. Thus, during the addressing period, each row is sequentially addressed to place desired pixels in the ON state.

During the sustain period, a common sustain pulse is applied to all scan electrodes to repetitively generate plasma discharges at each sub-pixel addressed during the addressing period. That is, if a sub-pixel is turned ON during the address period, the pixel is repetitively discharged in the sustain period to produce a desired brightness.

In order to exhibit a full color image on a plasma display panel (PDP) from a video source, a proper driving scheme is needed to achieve sufficient gray scale and minimize motion picture distortion. In AC plasma display panels, a widely used driving scheme to accomplish gray scale in pixels is the so called ADS (address display separated) suggested by Shinoda (Yoshikawa K, Kanazawa Y, Wakitani W, Shinoda T and Ohtsuka A, 1992 Japan. Display 92, 605).

Referring to FIG. 4, it can be seen that in this method, a frame time of 16.7 milliseconds (one TV field) is divided into eight sub-fields, designated as SF1-SF8. Each of the eight sub-fields is further divided into an address period and a sustain period, i.e., display period. Pixels previously addressed during address period are turned on and emit light during sustain period. The duration of the sustain period depends on the particular sub-field. By controlling the addressing of each sub-pixel for a given pixel during addressing period, the intensity of the pixel can be varied to any of the 256 gray scale levels.

The physical size of a pixel is an important aspect of high resolution PDPs. The high resolution PDP, especially in smaller panel sizes, requires smaller pixels and sub-pixels. As a result, the gas discharge space is limited, which adversely affects the luminance efficiency of the panel. Accordingly, there is a need for a high-resolution PDP that addresses these disadvantages of the currently available systems.

### SUMMARY OF THE INVENTION

The sub-pixel structure of the present disclosure includes a dielectric step or stand between two electrodes across the sustain gap, and on top of the dielectric layer on the front plate in each sub-pixel of plasma displays. The particular structure can lengthen the discharge path in the dimension that is perpendicular to the front plate. As a result, a significant improvement of luminance efficiency can be achieved, even in very small pixel sizes. These dielectric stands can be used in very high resolution PDPs, such as a full HD plasma display, where very small pixels are needed. The dielectric stand can also help to reduce the voltage needed for the gas discharge in each sub-pixel because of field enhancement near the bottom edge of the step.

### BRIEF DESCRIPTION OF THE DRAWINGS

FIG. 1 is a perspective view of a conventional color plasma display structure according to the prior art.

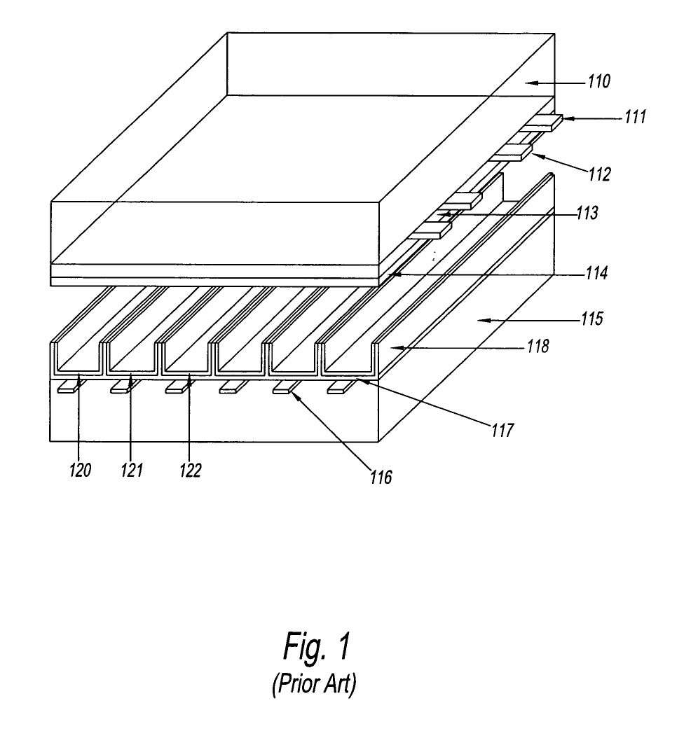

FIG. 2 is a side view of a sub-pixel of the color plasma display panel of FIG. 1, taken along a plane perpendicular to a long dimension of an address electrode.

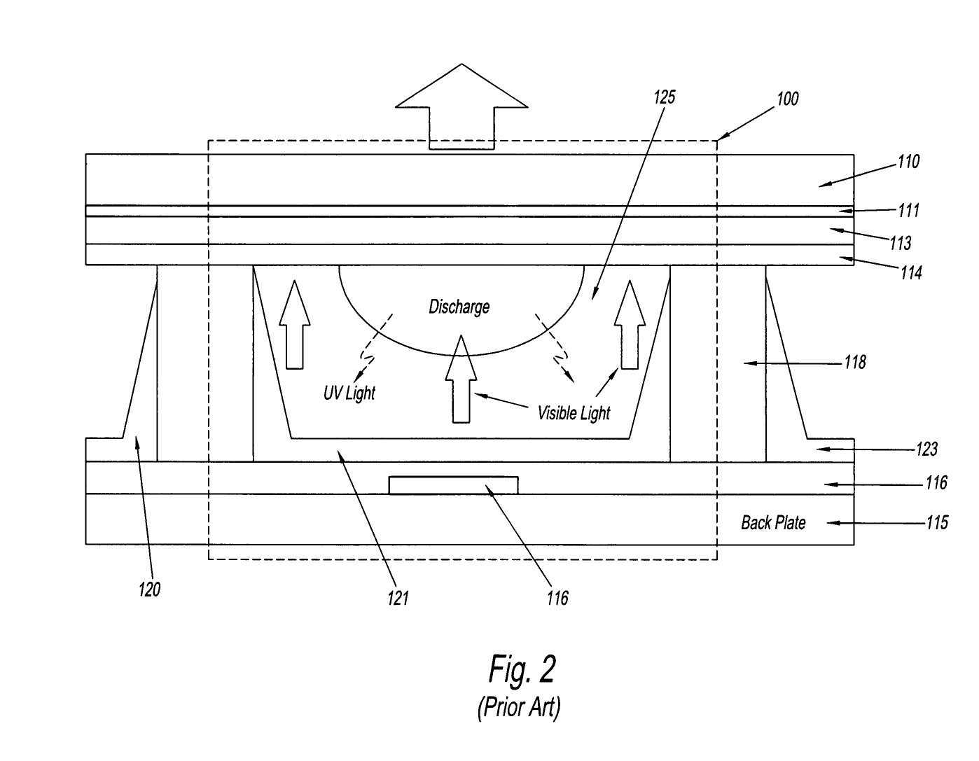

FIG. 3 is another side view of a sub-pixel of the color plasma display panel of FIG. 1, taken along a plane parallel to the long dimension of the address electrode, and showing the sub-pixel in a plane perpendicular to the plane of FIG. 2.

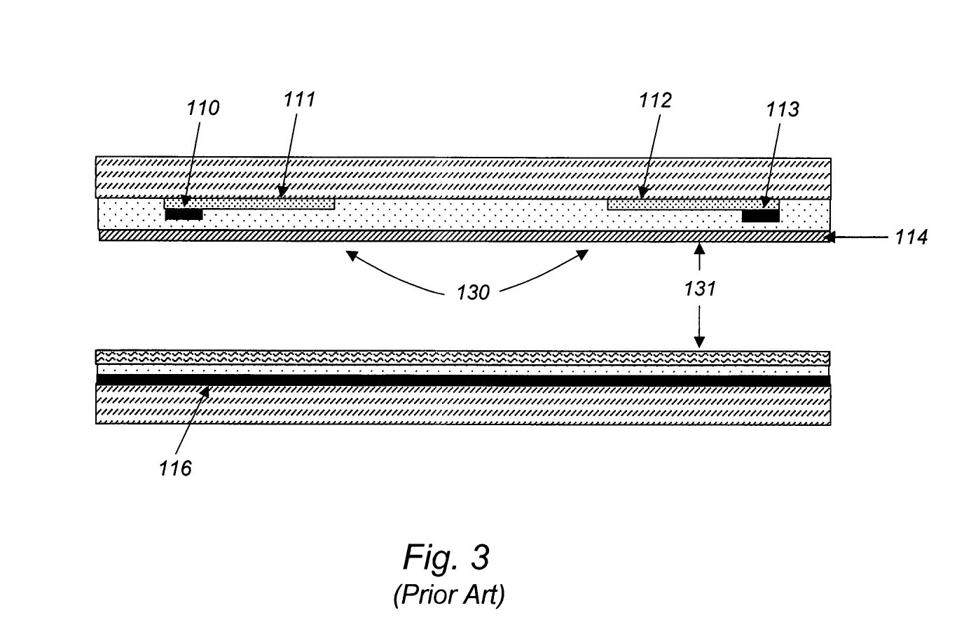

FIG. 4 is a diagram of a driving scheme of an address display separation (ADS) gray scale technique, showing a frame time divided into sub-fields.

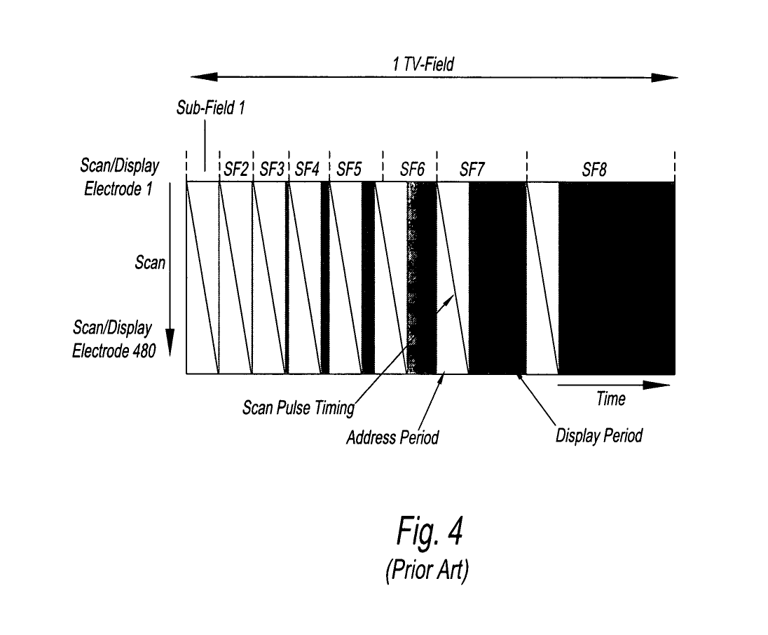

FIG. 5 is a diagram of a PDP pixel structure with a transparent dielectric stand of the present disclosure.

FIG. 6 is a diagram of another embodiment of a pixel structure with a transparent dielectric stand of the present disclosure.

FIG. 7 is a diagram of a second embodiment of a pixel structure with a transparent dielectric stand of the present disclosure.

FIG. 8 is a diagram of a third embodiment of a pixel structure with a transparent dielectric stand of the present disclosure.

FIG. 9 is a diagram of a fourth embodiment of a pixel structure with a transparent dielectric stand of the present disclosure.

FIG. 10 is a diagram of a fifth embodiment of a pixel structure with a transparent dielectric stand of the present disclosure.

FIG. 11 is a diagram of a sixth embodiment of a pixel structure with a transparent dielectric stand of the present disclosure.

FIG. 12 is a diagram of a seventh embodiment of a pixel structure with a transparent dielectric stand of the present disclosure.

FIG. 13 is a diagram of an eighth embodiment of a pixel structure with a transparent dielectric stand of the present disclosure.

FIG. 14 is a diagram of a ninth embodiment of a pixel structure with a transparent dielectric stand of the present disclosure.

FIG. 15 is a diagram of a tenth embodiment of a pixel structure with a transparent dielectric stand of the present disclosure.

FIG. 16 is a diagram of an eleventh embodiment of a pixel structure with a transparent dielectric stand of the present disclosure.

FIG. 17 is a diagram of a twelfth embodiment of a pixel structure with a dielectric stand of the present disclosure.

### DETAILED DESCRIPTION OF THE INVENTION

A long discharge path within a sub-pixel of a PDP is believed to improve the discharge efficiency of that sub-pixel because a positive column is involved in the discharge. A high-resolution PDP limits the size of each sub-pixel, so that the only way to increase the discharge path is in the dimension perpendicular to the flat plane of the front plate of the panel. The present disclosure thus describes a structure comprising a dielectric step or stand between two electrodes, across the sustain gap, and on top of the dielectric layer on the front plate in each sub-pixel of a PDP. The particular structure can lengthen the discharge path in the dimension that is perpendicular to the front plate. As a result, there is a significant improvement in luminescence efficiency over currently available models, even in HD resolution PDPs. The structure can also reduce the discharge voltage needed for each sub-pixel because of field enhancement near the bottom edge of the step.

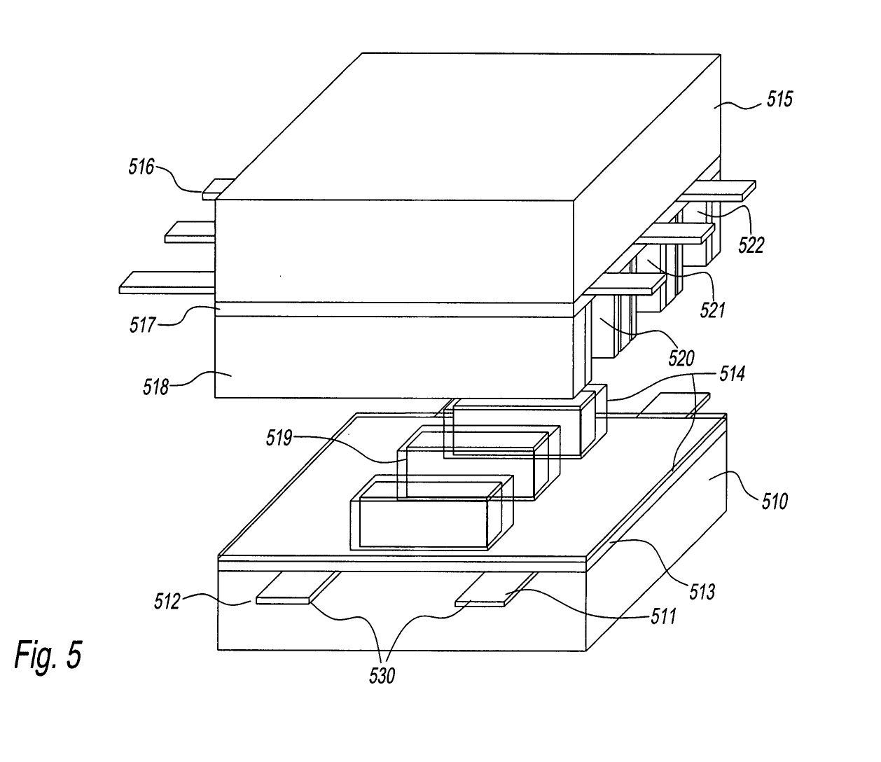

In the first embodiment shown in FIG. 5, a transparent dielectric stand 519 is placed on top of dielectric layer 513 and in between scan electrode 511 and sustain electrode 512 on the front plate 510. The protective layer 514 is coated on top of dielectric layer 513 and dielectric stand 519. In the shown embodiment, the protective coating is made of MgO thin film. However, any suitable material can be used for the protective coating, such as those listed in co-pending application Ser. No. 11/432,143, entitled “Plasma Display Panel with Low Voltage Material,” filed on May 11, 2006, and incorporated herein by reference.

In the embodiment of FIG. 5, the dielectric stand 519 is located in the center of the sustain gap 530, with a length slightly less than that of the sustain gap 530 and its width close to the width of phosphor channel 520 (or 521, 522) on the back plate 515. In the preferred embodiment, the length of the dielectric stand 519 is about 20 micrometers less than the length of sustain gap 530. The distance between the width of the dielectric stand 519 and the wall of the phosphor channels 520, 521, or 522 is preferably about 10 micrometers or less on each side.

The height of the ribs that define the sub-pixels in the back plate should be adjusted to accommodate the dielectric stand on the front plate. The higher rib height can also increase the phosphor area to further enhance the brightness of the panel. The height of the dielectric stand 519 can be varied significantly, but is preferably between about 20 micrometers and about 300 micrometers. The depth of rib 518 on glass back plate 515 should be adjusted according to the height of the dielectric stand 519, so that the gap between the top of dielectric stand 519 and the bottom of phosphor channel 520, 521, or 522 is between about 50 micrometers and 200 micrometers. Preferably, the gap is about 100 micrometers.

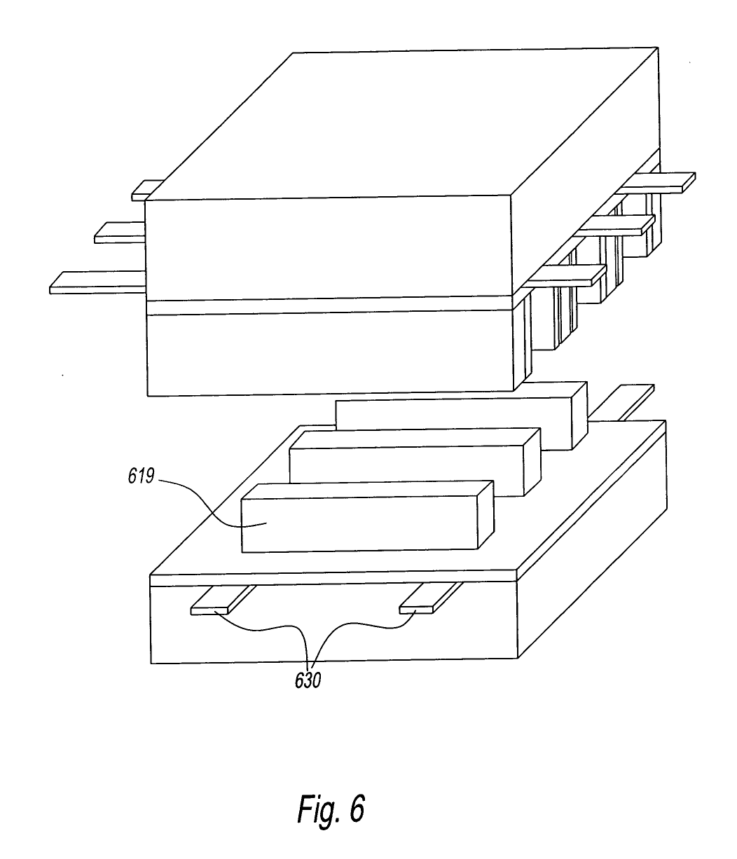

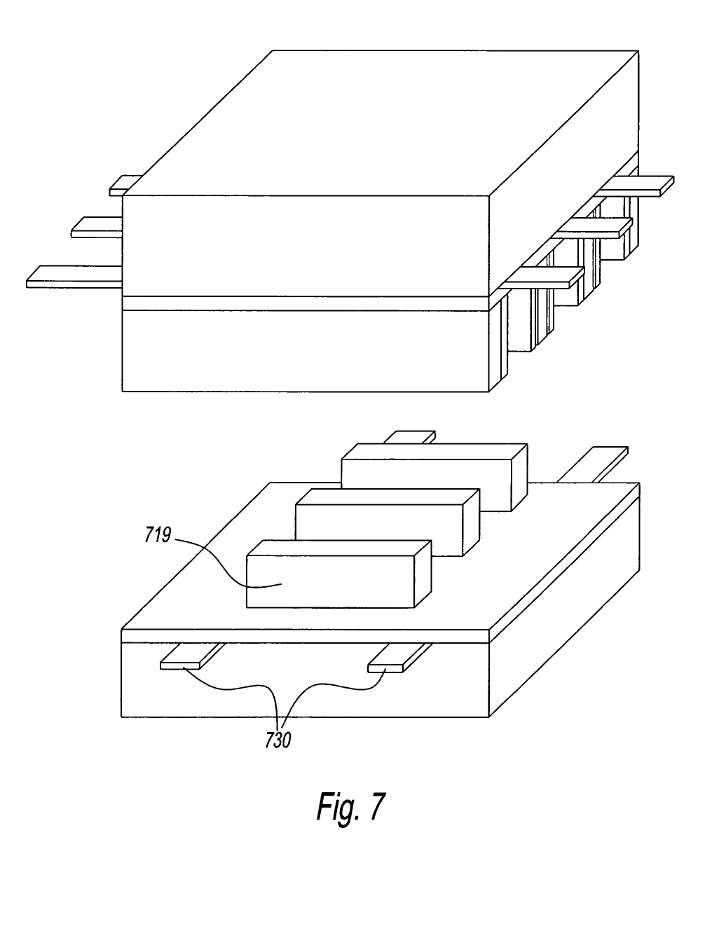

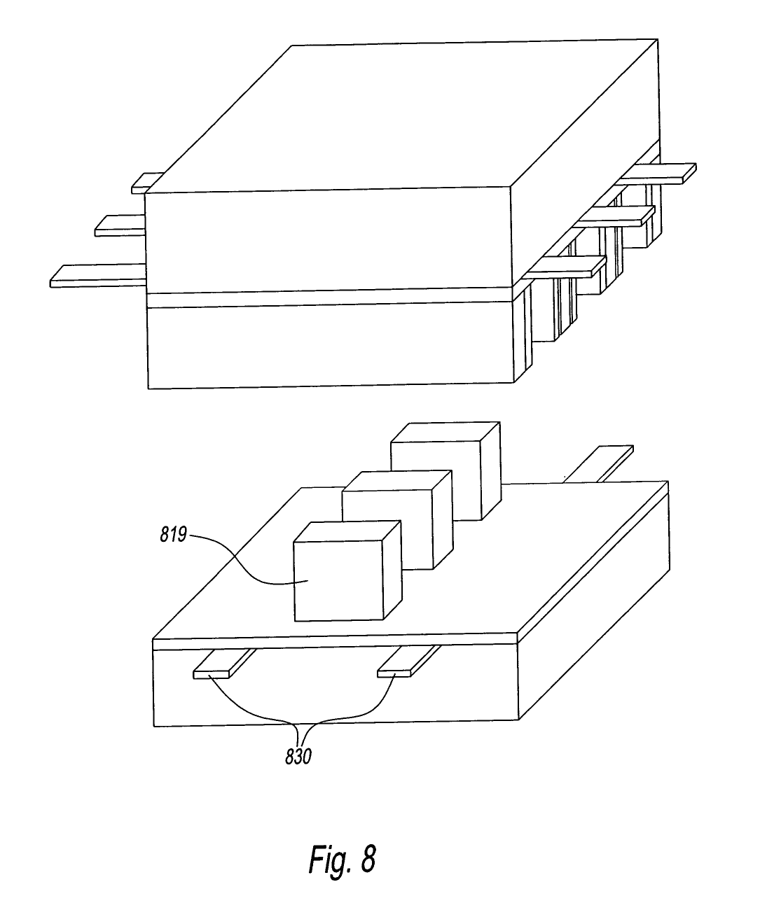

The length of the dielectric stand 519 can also vary from a size longer than sustain gap 530, such as about 100 micrometers longer than the sustain gap 530, to approximately 20 micrometers in overall length. Some of these embodiments are shown in FIGS. 6, 7, and 8. Referring to FIG. 6, a dielectric stand 619 that is slightly larger than sustain gap 630 is shown. Referring to FIG. 7, a dielectric stand 719 that is the same size as sustain gap 730 is shown. Referring to FIG. 8, a dielectric stand 819 that is smaller than the sustain gap 830 is shown.

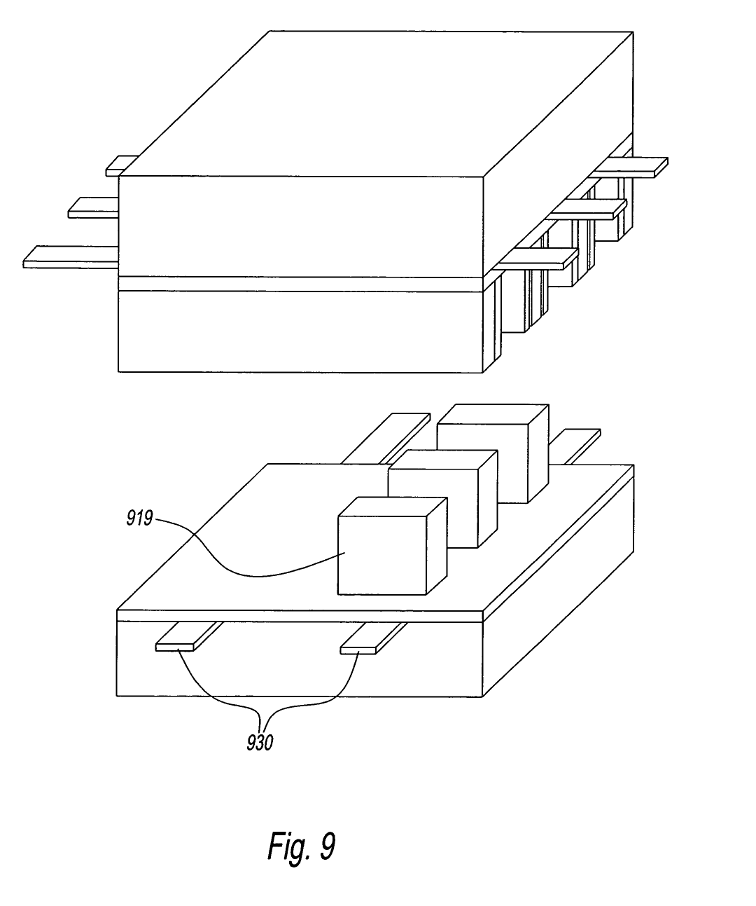

The dielectric stand of the present disclosure can also be placed off-center of the sustain gap, as is illustrated by dielectric stand 919 of FIG. 9.

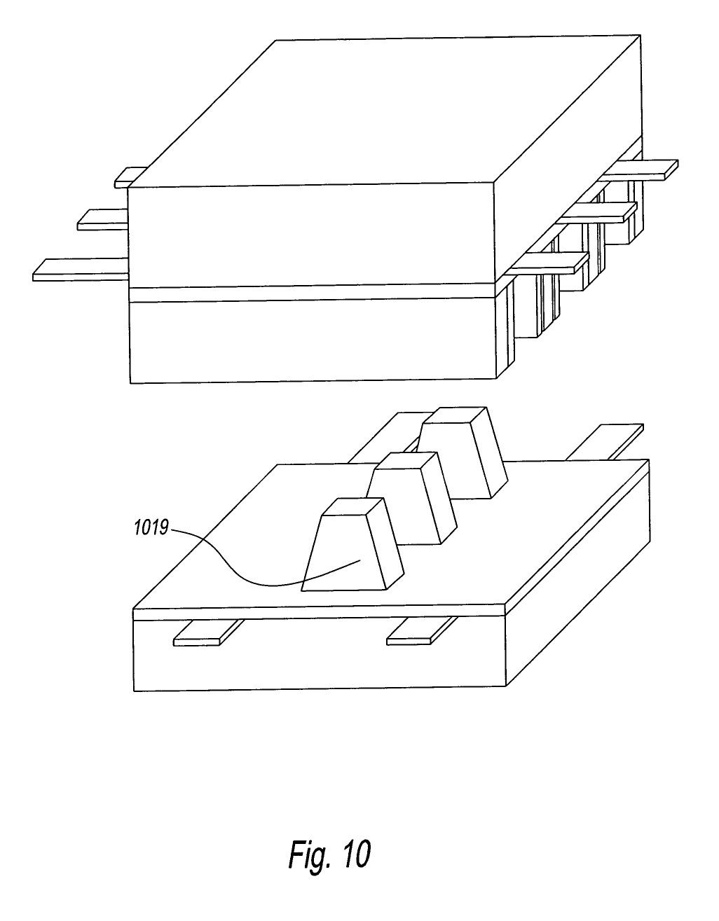

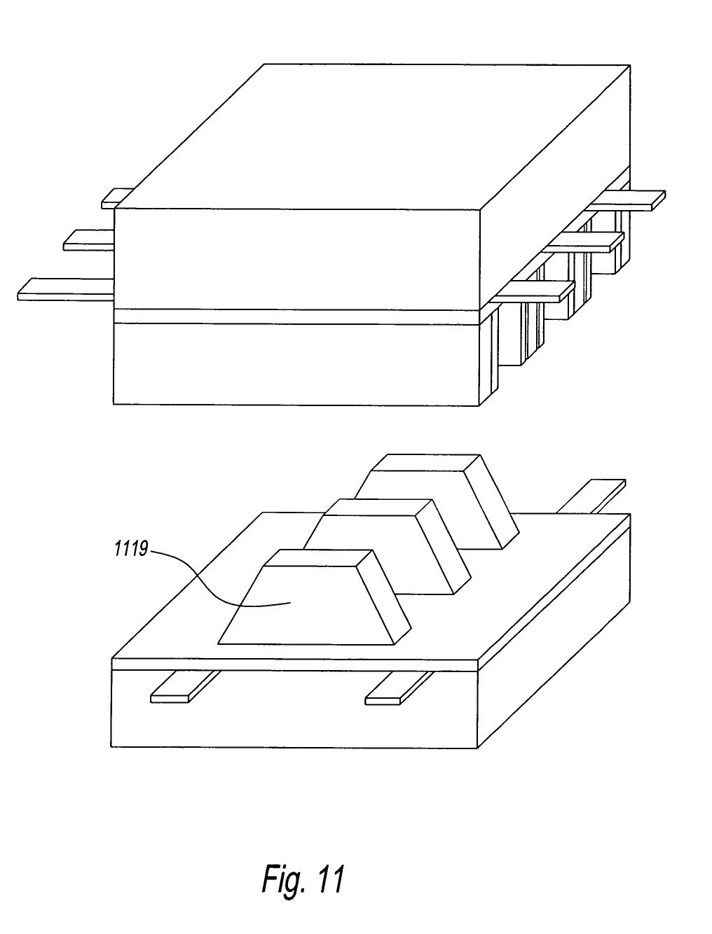

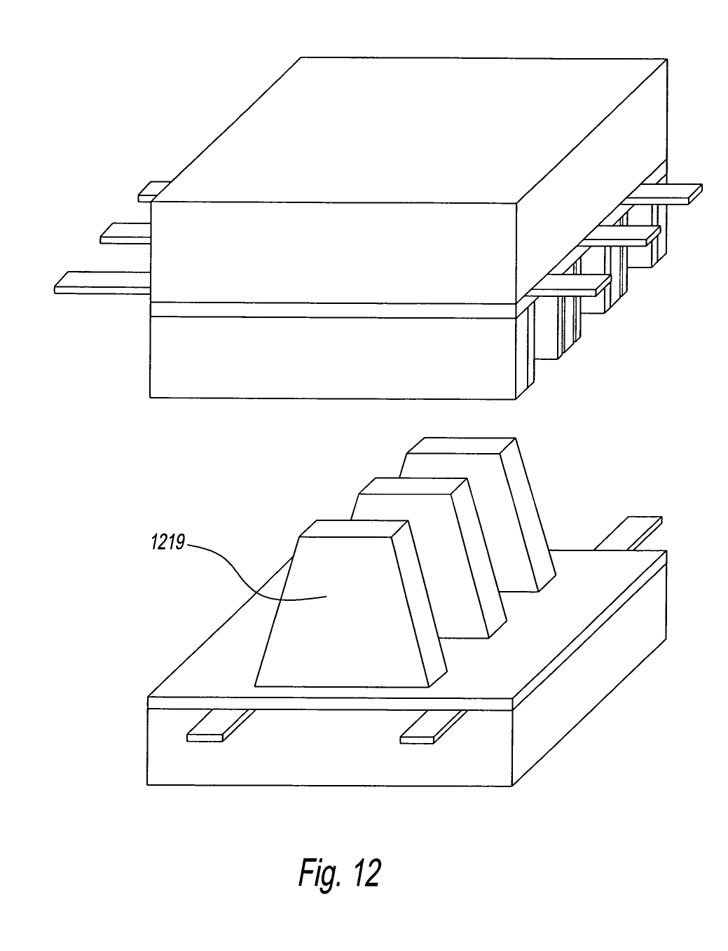

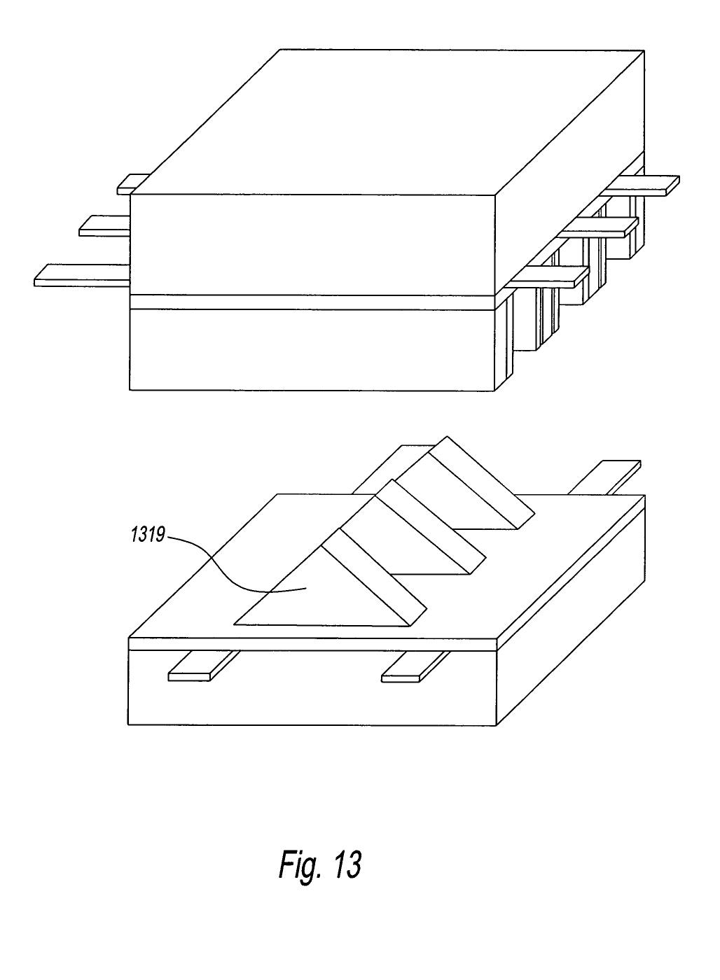

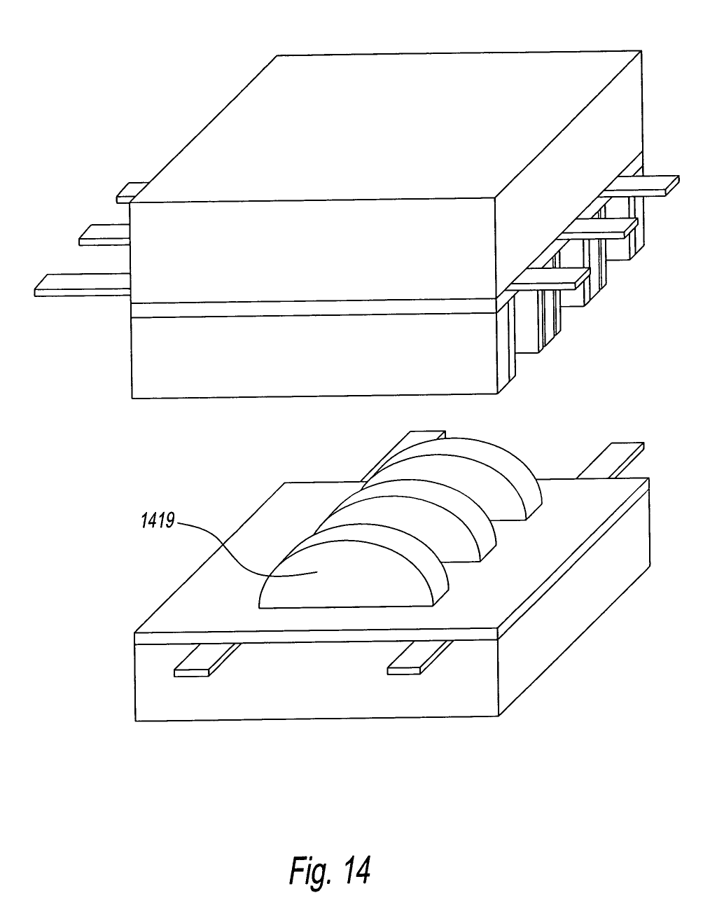

The shape of the dielectric stand can also vary from a rectangular shape to other shapes shown in FIGS. 10 though 14. These shapes include the trapezoidal shaped dielectric stands 1019, 1119, and 1219 of FIGS. 10, and 11, 12, respectively, the triangular shaped stand 1319 of FIG. 13, or the semi-circular shaped stand 1419 of FIG. 14.

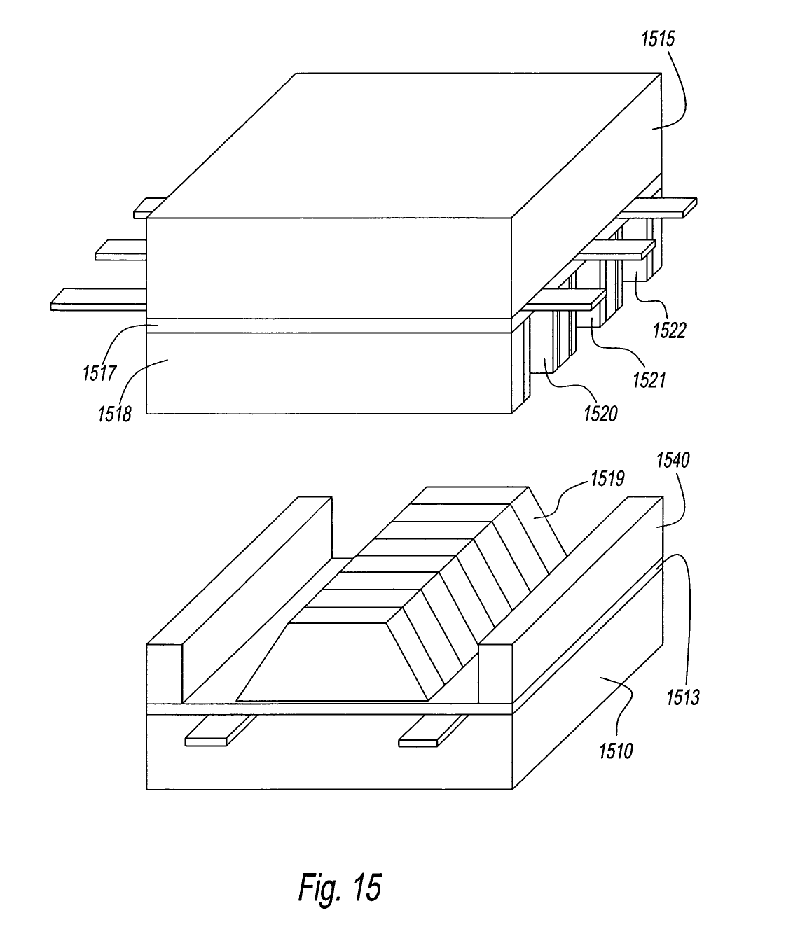

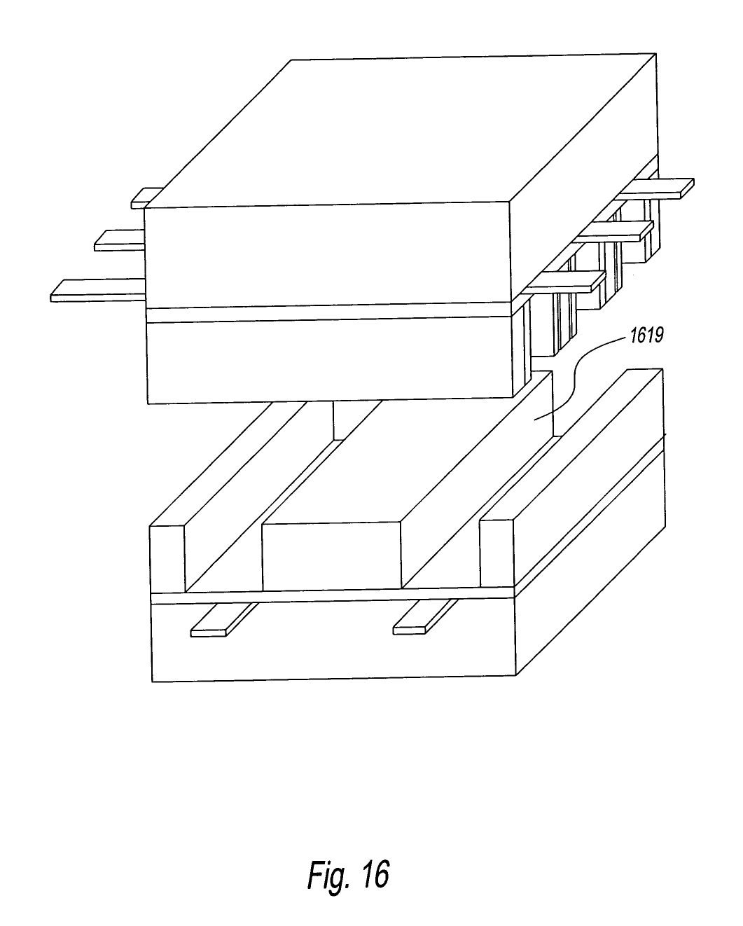

Referring to FIG. 15, another embodiment of the present disclosure is shown. Dielectric stand 1519 of the shown embodiment is a continuous strip that is placed on top of dielectric layer 1513 and runs across phosphor channels 1520, 1521, and 1522, as opposed to the stands of previous embodiments that only occupy one phosphor channel at a time. Back glass plate 1510 and dielectric layer 1513 also have back rib 1540 connected thereto, which blocks the discharge path from crossing over into other sub-pixels. Dielectric stand 1519 is advantageous in that it is easier to manufacture and assemble. However, due to the fact that the phosphor channels 1520, 1521, and 1522 are not isolated from each other in this embodiment, there will be some interference or “cross-talk” between the channels that will affect the image quality of the panel as a whole. Barrier walls around the sub-pixel, however, can prevent “cross-talk” between neighboring sub-pixels in both the horizontal and vertical directions. The height of dielectric stand 1519 can be between about 20 micrometers and about 1000 micrometers. Referring to FIG. 16, dielectric stand 1619 is shown, which is substantially similar to dielectric stand 1519, with the exception that it is rectangularly shaped. In both of the embodiments shown in FIGS. 15 and 16, the dielectric stands are coated with a protective layer, for example with a layer made of MgO.

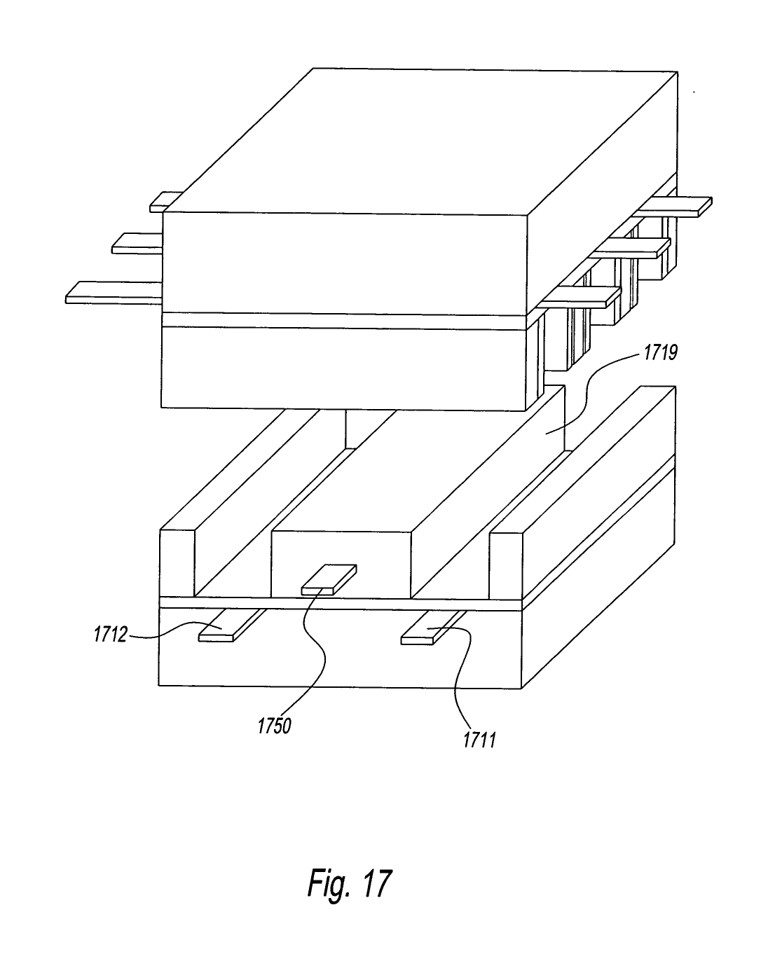

Referring to FIG. 17, another embodiment of the present disclosure is shown, and has dielectric stand 1719, sustain electrode 1711, and scan electrode 1712, which are similar to sustain electrode 511 and scan electrode 512 of FIG. 5, respectively. In this embodiment, an additional electrode 1750 is embedded inside dielectric stand 1719. There can be one or more electrodes 1750 located inside dielectric stand 1719, and these electrodes 1750 can also be located anywhere within dielectric stand 1719. The electrodes 1750 can be utilized to force the discharge path around dielectric stand 1719, thus maximizing the length of the path. Preferably, the additional electrode is made of transparent conducting material such as Indium Tin Oxide.

The transparent dielectric stands or steps of the present disclosure are formed by a photolithographic process. Photosensitive transparent dielectric tape or thick film is laminated or screen printed on top of a normal dielectric layer or directly on glass with pre-patterned metal electrode lines. A photolithographic process is used to pattern the transparent layer, and as a result the dielectric stand or steps can be created. One or more layers of photosensitive transparent dielectric tape can be applied for creating thick dielectric stands or steps.

Table 1 below shows a luminous efficacy comparison between a conventional PDP, and PDPs with the dielectric stand structures of the present disclosure. The “Panel with dielectric stand-1” structure is very similar to the PDP structure shown in FIG. 7, namely one where the dielectric stand is the same length as the sustain gap. This dielectric stand is 20 micrometers thick, made of transparent dielectric material, and made by the photolithographic process described above. The “Panel with dielectric stand-2” PDP is similar to the “Panel with dielectric stand-1” PDP, with the exception that the dielectric stand is 20 micrometers longer than the sustain gap of the PDP. This is similar to the embodiment shown in FIG. 6.

The “Panel with dielectric stand-1” PDP has a luminous efficacy of 1.97 (Lum/W), about 23% higher than the luminous efficacy of the PDP without the dielectric stand. The gas mixture in the panel is Neon with 15% Xenon, at operating voltage of 155V. The luminous efficacy of the “Panel with dielectric stand-2” PDP is 1.89 Lum/W, 18% higher than the efficiency of the conventional PDP without the dielectric stand. The operating voltage of the PDP of the present disclosure structure is almost the same as a conventional PDP. Conventional PDPs can operate at an approximate voltage of 155V, and the PDPs of the present disclosure vary by only approximately 2 volts. These results clearly demonstrate that the PDPs of the present disclosure, which include a dielectric stand, can significantly increase the luminous efficacy of the PDP without significantly increasing the operating voltage. The improved luminous efficacy of the PDPs of the present disclosure is not limited to the data shown in Table 1, as this is merely one specific example.

The present disclosure has been described with particular reference to the preferred embodiments. It should be understood that the foregoing descriptions and examples are only illustrative of the invention. Various alternatives and modifications thereof can be devised by those skilled in the art without departing from the spirit and scope of the present disclosure. Accordingly, the present disclosure is intended to embrace all such alternatives, modifications, and variations that fall within the scope of the appended claims.

What is claimed is:

1. A plasma display panel, comprising:
a first substrate;
a plurality of electrodes disposed on said first substrate;
a dielectric layer disposed on top of said electrodes; and
at least one dielectric stand disposed on said dielectric layer and between said electrodes.

2. The plasma display panel of claim 1, further comprising:
a second substrate;
a plurality of electrodes disposed on said second substrate;
a plurality of barrier ribs disposed between said electrodes on said second substrate and perpendicular to said second substrate; and
a phosphor layer disposed between said barrier ribs, so that when said second substrate is placed on top of said first substrate, said dielectric stand is disposed within a phosphor channel defined by said phosphor layer and said barrier ribs.

3. The plasma display panel of claim 1, wherein said first substrate and said dielectric stand are coated with a protective layer.

4. The plasma display panel of claim 3, wherein said protective layer comprises at least one material selected from the group consisting of magnesium oxide and a material having the formula MₓMg₁₋ₓO, wherein x is 0.01<x<1, and wherein M is a metal selected from the group consisting of: Be, Ca, Sr, Ba, Ra, Sc, Y, Ti, Zr, Hf, V, Nb, Ta, Zn, Na, Al, and mixtures thereof.

5. The plasma display panel of claim 1, wherein said dielectric stand is centrally disposed between said electrodes on said first substrate.

6. The plasma display panel of claim 5, wherein the length of said dielectric stand is between about 20 micrometers to about 200 micrometers less than the distance between said electrodes on said first substrate.

7. The plasma display panel of claim 1, wherein said dielectric stand has a height in the range between about 20 and about 300 micrometers.

8. The plasma display panel of claim 2, wherein the distance between a top side of said dielectric stand and a bottom side of said phosphor channel is between about 50 micrometers and about 200 micrometers.

9. The plasma display panel of claim 8, wherein said distance is about 100 micrometers.

10. The plasma display panel of claim 1, wherein said dielectric stand is longer than the distance between said electrodes on said first substrate.

11. The plasma display panel of claim 10, wherein said dielectric stand is about 20 to about 100 micrometers longer than said distance between said electrodes on said first substrate.

12. The plasma display panel of claim 1, further comprising an additional electrode disposed within said dielectric stand.

13. The plasma display panel of claim 1, wherein the shape of said dielectric stand is at least one shape selected from the group consisting of: rectangular, trapezoidal, triangular, and semi-circular.

14. The plasma display panel of claim 1, further comprising:
a second substrate,
a plurality of electrodes disposed on said second substrate;
a plurality of barrier ribs disposed between said electrodes on said second substrate and perpendicular to said second substrate;
a phosphor layer disposed between said barrier ribs on said second substrate; and
a plurality of barrier ribs disposed on said first substrate and perpendicular to said first substrate, wherein two electrodes are disposed between said barrier ribs on said first substrate, so that said dielectric stand is disposed between said electrodes on said first substrate.

15. The plasma display panel of claim 14, wherein said first substrate and said dielectric stand are coated with a protective layer.

16. The plasma display panel of claim 15, wherein said protective layer comprises at least one material selected from the group consisting of magnesium oxide and a material with the formula MₓMg₁₋ₓO, wherein x is 0.01<x<1, and wherein M is a metal selected from the group consisting of: Be, Ca, Sr, Ba, Ra, Sc, Y, Ti, Zr, Hf, V, Nb, Ta, Zn, Na, Al, and mixtures thereof.

17. The plasma display panel of claim 14, wherein said dielectric stand has a height in the range between about 20 and about 1000 micrometers.

18. The plasma display panel of claim 14, further comprising an additional electrode disposed within said dielectric stand.

19. The plasma display panel of claim 13, wherein the shape of said dielectric stand is at least one shape selected from the group consisting of: rectangular, trapezoidal, triangular, and semi-circular.
